(19) United States
(12) Patent Application Publication
(10) Pub. No.: US 2019/0093914 A1
(43) Pub. Date: Mar. 28, 2019

(54) STAND-ALONE PROGRAMMABLE THERMOSTAT AND METHOD FOR TRANSMITTING HEATING DATA TO THE THERMOSTAT

(71) Applicant: Tapio Veli Juhani RISTIMÄKI, Iittala (FI)

(72) Inventor: Tapio Veli Juhani RISTIMÄKI, Iittala (FI)

(21) Appl. No.: 16/142,430

(22) Filed: Sep. 26, 2018

(30) Foreign Application Priority Data
Sep. 27, 2017 (NO) 20171547
Dec. 14, 2017 (EP) 17397529.3

(51) Int. Cl. F24F 11/47; F24F 11/523; F24F 11/58; F24F 11/64; F24F 11/65; F24F 11/88; G05B 19/042

(52) U.S. Cl. CPC F24F 11/47; F24F 11/523; F24F 11/58; F24F 2110/10; F24F 11/65; F24F 11/88; G05B 19/042; F24F 11/64

(57) ABSTRACT

Stand-alone programmable thermostat and a method for transmitting heating data to the thermostat. The stand-alone programmable thermostat comprises an antenna for receiving heating data, digital means for storing and processing the received heating data and a real-time clock. The thermostat is a displayless type programmable dial thermostat comprising a knob to set a base target temperature.

The present invention relates to a stand-alone programmable thermostat as defined in the preamble of claim 1 and a method for transmitting heating data to the thermostat as defined in the preamble of claim 12.

The invention in question relates to a stand-alone programmable thermostat, which is displayless type dial thermostat, and which configuration can be performed entirely or at least mostly with a mobile device. The structure of this thermostat typically consists of a setting dial, such as a temperature dial and a rotary knob for setting a base target temperature, a power source, a temperature sensor, an antenna, a microcontroller that incorporates RF functionality, a data storage, a relay, a potentiometer, a real time clock and a led indicator.

The invention in question relates also to a method for transmitting heating data to the thermostat. The heating data may be, for example, a weekly heating program. Typically, the heating data comprises at least one or more sets of heating instructions, which instructions preferably comprise a target thermostat identification information, date information, starting time information, finishing time information and a target temperature information. The heating data will be received by a mobile application and transmitted from the mobile application to the displayless thermostat. The heating data may be received directly from a user utilizing a mobile device user interface or the heating data can be formed and optimized by the mobile device application based for example on an electricity spot prices data, which the mobile device receives through the internet.

The principle purpose of the invention is to make it possible to offer the features of a smart programmable thermostat in a stand-alone thermostat equipped with a very limited user interface. The thermostat and the method according to the invention, later called also as the solution, is used to regulate temperature of a heating device. A heating device controlled by the thermostat according to the invention may be separate from the thermostat or the thermostat may be housed into one entity with the electric heating device. The heating device can be for example a room or space heater or a floor heating arrangement.

It is known, and also mainly done, to control a heating device, that heats a space or room or floor, with a thermostat. The thermostat switches the heater on when it is too cold in the space and switches the heater off when it is too hot in the space or floor. The thermostat may also use more sophisticated control algorithms, in which case the heater is switched on and off quickly to achieve an even temperature. The user sets the desired base target temperature on the thermostat. With reverse functionality a thermostat may also be used to control cooling of a space. Lowest-priced thermostats are based on the thermal expansion of different metals. Therefore, they are called bimetal thermostats. Mid-dle-priced thermostats are based on a relay that is controlled with analog electronics or a semiconductor, and the most expensive thermostats are microprocessor-controlled. In the lowest-priced thermostats, the user sets a base target temperature with a physical rotary knob and the most expensive thermostats have a display unit.

It is also known that a thermostat may be a smart display thermostat. The most important additional feature of a smart display thermostat is a programmable base target temperature that varies with the day of a week and time of a day. With varying the base target temperature, the user can save energy costs of the heating. Smart thermostats typically addi-tionally include a large number of configuration possibili-ties.

It is also known that a regulation of the temperature is a part of a home automation system. In these kinds of systems, the settings are made, for example, through the home automation system and any room unit receives instructions through the home automation system.

It is also known that a stand-alone thermostat with a display may have a wireless connection to a mobile device. In these known solutions, the user can set some of the settings directly with the thermostat's display unit and some or all settings also with the mobile device.

It is also known that a thermostat can be connected to the internet or a home network. A terminal device, which is connected to the same internet or the home network as the thermostat, can control and adjust the configurations of such thermostat.

US patent publication No. US2016/040903 A1 presents a thermostat that can be connected via bluetooth and Wi-Fi. However, the thermostat of the US-publication is not an inexpensive displayless thermostat that would comprise a simple knob to set a target temperature. US-publication mentions that its thermostat may have a minimal display of temperature, set point, mode (heat, cool, off) and a fan control. The US-publication also mentions that a pass key can be dis-played. That function also requires a display. It is also obvious that the thermostat according to US publication has no knob to set a target temperature. In that case the target temperature must be set remotely, or up/down buttons may be used to control a set point, as mentioned in the US publication. Thus, the thermostat of the US publication is not an inexpensive thermostat with a temperature dial and a simple setting knob but a more expensive smart thermostat, such as mentioned above.

US patent publication No. US2007/206740 A1 presents a method and apparatus for setting programmable features of an appliance. According to the US publication the term “appliance” here will be understood to include any device or system that has programmable features, and all the settings are made with a computer. A thermostat is mentioned as one of the ap-pliances but the US publication concentrates mainly only on the way of making a week program with a computer. The US publication is silent about thermostats where the target temperature is set with a rotatable knob.

European patent publication EP2733562 A2 presents a heating system that comprises a means to utilize electricity spot prices to optimize the electricity consumption costs in a certain type central heating arrangement. However, the presented prior art solution is not suitable for example to the space heating solutions where a heater to be controlled is mounted in a heat storage element, which is poorly insulated from the heated space such as a concrete floor. Thus, the device according to the present invention is capable of op-timizing energy consumption in a floor mounted space heater, where the prior art solution optimizes only the use of energy in central heating boilers. In poorly isolated masses such as floors, the above-described method of prior art is not suitable at all. And further, EP2733562 A2 gives no hint at all how to arrange spot price optimized data to a controller without a fixed connection to the data network. The solution to use mobile devices to share heating data optimized according to the spot price information with a controller is one of the inventive steps of the present invention.

Yet a further prior art publication, U.S. Pat. No. 8,550,369 B2, shows a method, where a rotary thermostat interacts with a user wirelessly via mobile devices such as smart phones or lap-tops and transmits heating data from the mobile device to the thermostat. However, this publication does not introduce a solution regarding an absence of a display unit, which is an inventive detail in the present invention. Vice versa, this prior art publication bases on a servo controlled rotatable knob, which comprises mechanical display functionality by itself.

The problem with the known solutions is that they are either stand-alone rotary or dial thermostats equipped with very limited features, expensive smart thermostats equipped with a display unit, thermostats without possibility locally give target temperature or thermostats that require a large automation system and/or home network to function. Among the known solutions, the affordable, stand-alone rotary thermostats without displays do not have smart thermostat features, like programmability, especially weekly programming feature. Offering smart thermostat features in thermostats in the lower-priced category would allow a significantly higher number of end users to have the energy-saving features of the efficient heating. Incorporating the features of smart thermostats in lower-priced thermostats would give a competitive advantage to the producer of the product.

In addition to the aforementioned, the European Ecodesign 1188/2015 regulation requires programmable functionalities for all new thermostats in EU market area. All present programmable stand-alone thermostats comprise display unit, which increases manufacturing costs and selling price of thermostats.

One objective of the present invention is to eliminate draw-backs of prior art technology and to achieve a reliable, easy-to-operate and inexpensive stand-alone programmable displayless rotary thermostat or dial thermostat equipped with a very limited user interface still having the features of smart thermostats, particularly the weekly programming feature. It has a direct wireless connection to a mobile device utilizing applicable standards like Bluetooth, Wi-Fi, or mobile networks particularly for sending heating data, like a week program to the thermostat. Only limited settings of a thermostat, like a base target temperature, can be adjusted directly from the device itself, and the majority of the settings can only be adjusted through a mobile device.

The stand-alone programmable displayless thermostat according to the invention is characterized by what is disclosed in the characterization part of claim 1 and the method for transmitting heating data to the thermostat is characterized by what is disclosed in the characterization part of claim 12. Other embodiments of the invention are characterized by what is disclosed in the other claims.

In order to achieve the object of the invention the stand-alone programmable thermostat comprises, an antenna for receiving heating data, digital means for storing and processing the received heating data and a real-time clock. Advantageously, the thermostat is a displayless type programmable rotary thermostat with a setting dial, for example, a temperature dial.

Preferably, the thermostat according to the invention comprises a radio connected to the antenna, which antenna is arranged to receive heating data as radio messages, a microcontroller with a memory, which microcontroller is arranged to process and store the received radio messages, which thermostat further comprises a knob to set a base target temperature and a target temperature sensor by the help of which the microcontroller is arranged to measure the base target temperature set with the knob.

Advantageously, the method according to the invention for transmitting a data to the stand-alone programmable dial thermostat comprises a mobile device, a mobile device application, a heating data, an electric heating device, a stand-alone programmable rotary thermostat, which rotary thermostat comprises an antenna for receiving heating data, digital means for storing and processing the received heating data and a real-time clock. The electric heating device is controlled with a displayless dial thermostat which receives the heating data from the mobile device application and/or from a rotatable knob connected to the thermostat.

Thus, in order to achieve the objectives mentioned above, the present invention provides a stand-alone programmable displayless thermostat with a setting dial or scale and a rotatable knob, still having the features of more expensive programmable smart thermostats.

One advantage of the solution according to the invention is, that the thermostat device is simple and inexpensive to man-ufacture, which gives competitive advantage to its manufac-turer and savings to end users as well.

Another advantage of the solution according to the invention is that the programming of the thermostat is made via a mobile device by a user or automatically by an application, which runs in a background and utilizes electricity spot prices to optimize the energy costs. Presented spot price optimization solution does not need fixed network connection giving assembly and maintenance cost advantage over existing systems.

Yet another advantage of the solution according to the invention is that this affordable stand-alone, displayless thermostat device also complies the European Ecodesign 1188/2015 regulation.

In the following, the invention will be described in detail by the aid of example embodiments by referring to the en-closed simplified and diagrammatic drawings, wherein

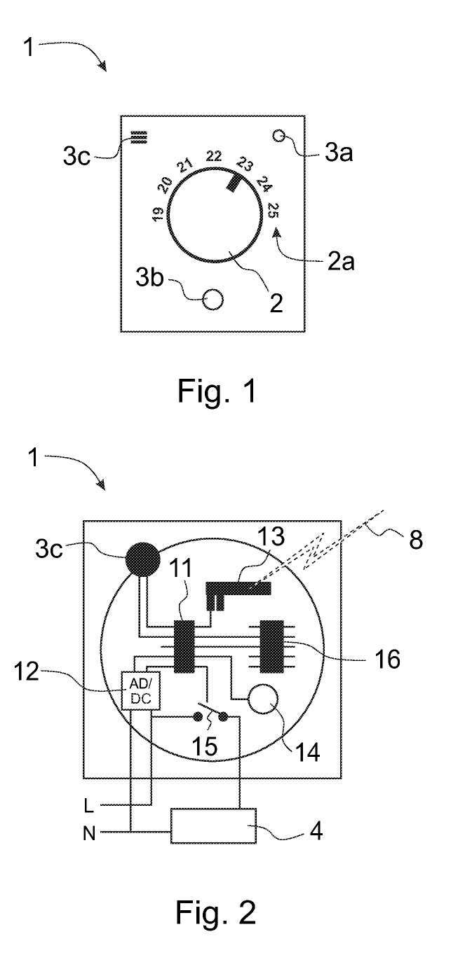

FIG. 1 presents in a simplified and diagrammatic front view a stand-alone programmable thermostat according to the invention,

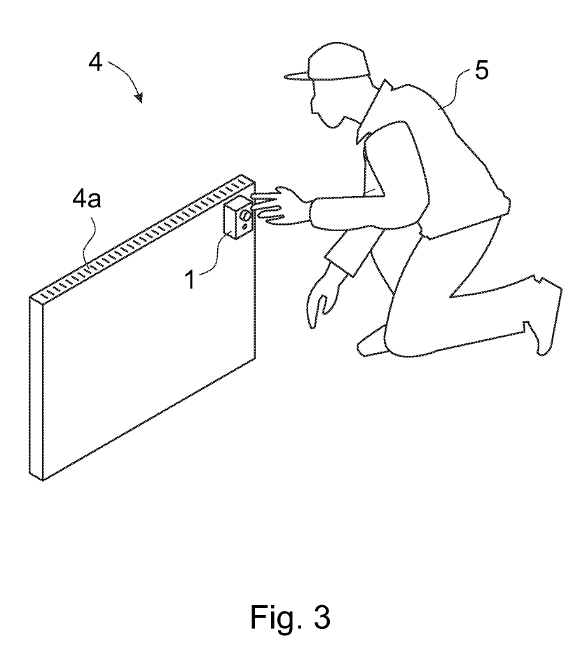

FIG. 2 presents in a simplified and diagrammatic view a wiring diagram of a stand-alone displayless programmable thermostat according to the invention,

FIG. 3 presents in a simplified and diagrammatic oblique view a user adjusting a temperature to the thermostat of a heating device,

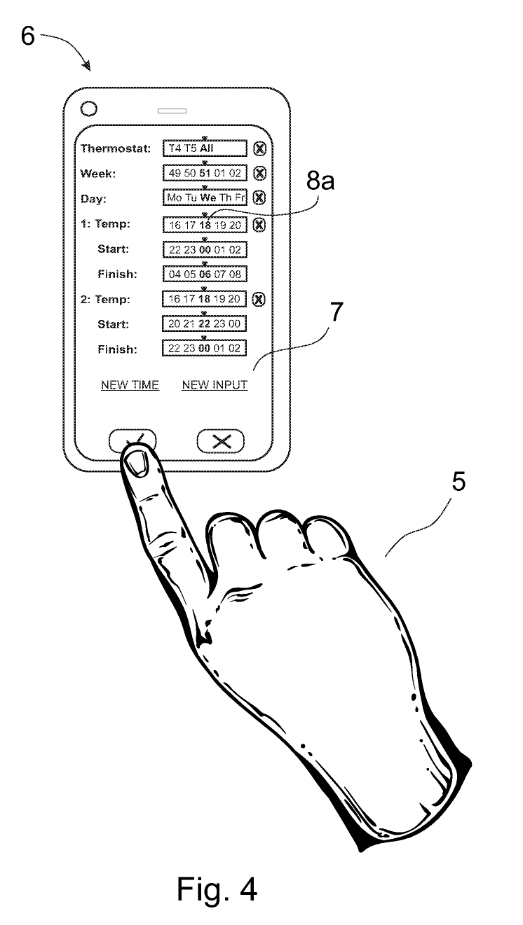

FIG. 4 presents in a simplified and diagrammatic front view a mobile device and a mobile device application, and

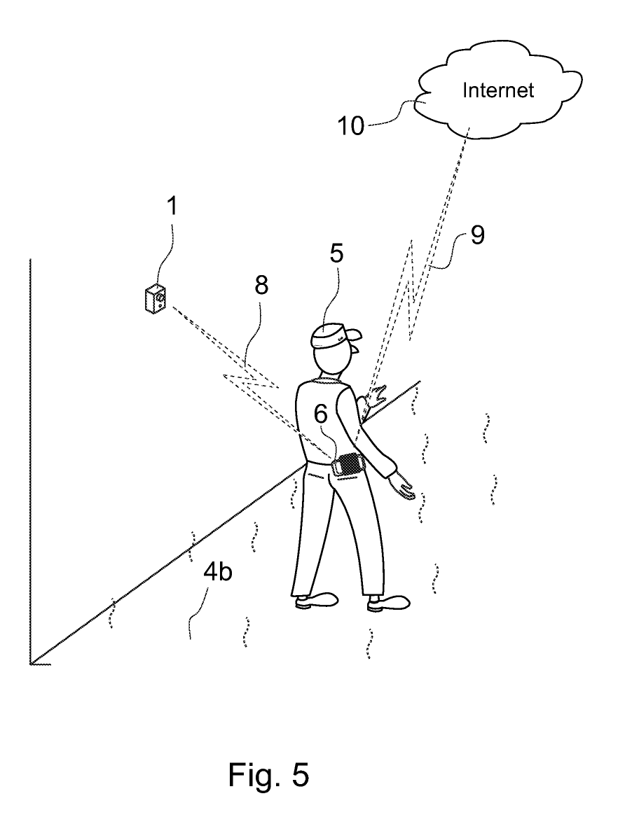

FIG. 5 presents in a simplified and diagrammatic oblique view an automatic heating data transmission in a floor heating arrangement.

An aspect of the invention is to achieve an inexpensive and easy solution and arrangement that complies present thermostat regulations.

FIGS. 1 and 2 present in a simplified and diagrammatic view a stand-alone programmable rotary or dial thermostat 1 according to the invention. FIG. 1 presents the thermostat 1 from outside and in a front view, and FIG. 2 presents a wiring diagram of a thermostat 1 according to the invention.

The term “rotary thermostat” or “dial thermostat” here means that the user interface of the thermostat 1 comprises a simple rotatable knob 2 and a setting dial 2a or temperature scale to set a wanted base target temperature. Instead of pure temperature values the setting dial 2a may comprise symbols to indicate wanted operation ranges, such as temperature ranges. In addition, the thermostat 1 comprises a temperature sensor 3c and indicator elements 3a and 3b, like illuminating leds, which indicate different states of the thermostat 1.

Noticeable is, that the thermostat 1 is a programmable smart thermostat, but it has no display. This reduces remarkably manufacturing costs of the thermostat and makes the thermostat more reliable.

Inside the case of the thermostat 1 there are means taking care of the various functions of the smart thermostat. These means are typically a power source 12 for the thermostat 1, a temperature sensor 3c, an antenna 13, a microcontroller 11 that incorporates RF function, a data storage, a real-time clock 16, a relay 15 and a potentiometer 14. Advantageously, the potentiometer 14 is connected with the rotatable knob 2 so that the rotation of the knob 2 also rotates the sliding contact or wiper of the potentiometer 14 for adjusting the base target temperature. The microcontroller 11 is arranged to measure the adjustment position of the wiper and using that data to deduce what is the base target temperature the user has set. Thus, instead of being only an adjustment element the potentiometer 14 also acts as a target temperature sensor for the microcontroller 11.

The thermostat 1 gets its power from the power source 12 and is arranged to control an electric heating device 4 with the relay 15. Preferably, the thermostat 1 comprises means to receive heating data from a mobile device, which heating data comprises, for example, a week heating program, a day heating program or other setting data for the thermostat 1.

The thermostat 1 is arranged to communicate with the mobile device through the microcontroller 11 via an antenna 13 connected to an internal RF circuit. The heating data sent by/from the mobile device is stored into the permanent memory of the microcontroller 11. The time information is stored into the real-time clock 16. The microcontroller 11 is arranged to measure real temperature data with one or more sensors 3c. With the potentiometer 14 the microcontroller 11 measures the base target temperature set by the user with the rotatable knob 2 and based on the measured value the microcontroller 11 decides whether to switch the relay 15 on or off based on the following: the base target temperature, measurements of the sensor 3c, received heating data, for example a week heating program or day heating program, time of real-time clock 16, temperature control algorithm and other settings. The thermostat 1 is arranged to indicate the state of the relay 15 to the user 5 with the LED light indicator element 3a.

The user 5 creates the week and/or day heating programs and other thermostat settings with an application 7 of a mobile device 6. The user 5 sends the created heating programs, settings and time as radio messages 8 to the thermostat 1. The heating programs sent by the user 5 are stored into a permanent memory of the microcontroller 11.

The indicator element 3b is arranged to indicate the user 5 when the thermostat 1 is overriding the physical temperature settings given by the rotatable knob 2. In that case the thermostat 1 uses the programmed heating data instead of the base target temperature. The programmed heating data preferably comprises a week or day heating program created by the user 5. Thus, when the indicator element 3b is illuminating the thermostat 1 uses modified target temperature according to the week or day heating program sent by the user 5 from the mobile device 6.

FIG. 3 presents in a simplified and diagrammatic oblique view a user 5 adjusting a temperature to the thermostat 1 of an electric heating device 4, in this case a wall heater 4a.

The user 5 sets the base target temperature of the wall heater 4a with the rotatable knob 2. Advantageously, the base target temperature is a so-called comfortable temperature, which applies when there are human beings present in the room or space. This base target temperature is effective when there is no other heating data set in the thermostat 1 and thus the indicator element 3b is not illuminating indi-cating that the base target temperature is effective. The base target temperature is set physically/manually using the rotatable knob 2 of the thermostat 1 of the wall heater 4a.

FIG. 4 presents in a simplified and diagrammatic front view a mobile device 6 and a mobile device application 7. The mobile device 6, such as a smart phone, tablet computer or other portable PC comprises the special mobile device application 7, with which heating data messages can be created and transmitted to the thermostat 1. The mobile device application 7 receives the heating data 8a from the user 5, who inputs the heating data 8a using the mobile device 6 user interface, like a touch screen.

The heating data 8a comprises one or more sets of parameters, where one set of parameters comprises target thermostat identification information, date information, target temperature information, starting time information and finishing time information. The mobile device application 7 is arranged to collect the parameter sets and to create the heating data 8a to be transmitted to the thermostat 1. The heating data 8a may, for example, comprise a week heating schedule or program or a day heating schedule or program. Advantageously, the thermostat 1 may have means to transmit the heating data 8a forward to the next or other thermostat or thermostats. The thermostat 1 is arranged to use the same means to receive the heating data 8a from another thermostat than receiving the heating data 8a from the mobile device 6.

FIG. 5 presents in a simplified and diagrammatic oblique view an automatic heating data 8a transmission in a floor heating arrangement, which comprises the thermostat 1 and the electric heating elements 4b inside the floor. Thus, in that case the electric heating device 4 comprises electric heating elements 4b.

Another method for creating the heating data 8a is an automatic heating data 8a formed by the mobile device application 7. For example, the mobile device application 7, which is running automatically at the background in the mobile device 6, downloads hourly based electric spot prices 9 for the next day through the internet. Based on the predeter-mined base target temperature set by the user 5 and hourly based electric spot prices 9, the mobile device application 7 forms cost optimized heating data 8a for the next day. The mobile device application 7 transmits the cost optimized heating data 8a automatically to the thermostat 1 as soon as the mobile device 6 is in the thermostat's data connection range. In that case the thermostat 1 controls the electric heating device 4, for example, the floor heating elements 4b maintaining the base target temperature, but in a cost optimized way.

It is obvious to the person skilled in the art that the invention is not restricted to the examples described above but that it may be varied within the scope of the claims presented below. Thus, for instance, the standard and proto-col used in transmitting the heating data may vary.

It is also obvious to the person skilled in the art that the thermostat may also read the position of the knob with sensors other than a potentiometer. There may be several different internal and external measuring sensors in the thermostat. The power source of the thermostat may be, for instance, a switched-mode power supply that produces DC volt-age from mains power, a capacitor dropper or battery. The permanent memory can be an internal or external feature of the microcontroller. The radio circuit may entirely or part-ly be an external implementation of the microcontroller. Instead of a traditional relay, a semi-conductor relay or other semiconductor may be used, and this is what is typically done, for instance in heating radiator thermostats. The knob may be a large ring such as in FIG. 1, or a very small one. The thermostat may have zero, one or several indication elements, like illuminating led lights.

It is further obvious to the person skilled in the art that the mobile device or the mobile device application may vary from what is presented above. Thus, for instance, the mobile device application may comprise other additional functionalities for controlling the thermostat.

It is still further obvious to the person skilled in the art that the thermostat may comprise a button or other actuating mechanism by which the user may force the thermostat into an energy saving mode overriding the base target temperature setting given by the user with the rotatable knob.

It is also obvious to the person skilled in the art that the temperature sensor for real temperature measurements may also be wired and located, for example, on a floor heating element.

It is also obvious to the person skilled in the art that instead of the rotatable potentiometer mentioned above the potentiometer may be a type of a linear slider potentiometer, which has a wiper that slides along a linear element instead of rotating.

It is further obvious to the person skilled in the art that instead of controlling the heating the thermostat according to the invention may also be used to control the cooling of a space.

It is still further obvious to the person skilled in the art that the thermostat may control the speed of a fan instead of the power of a heater. There may be several outputs making it possible to independently control several heating, cooling and fan units by a single thermostat. Also, instead of pure temperature values the setting dial of the thermostat may comprise symbols to indicate other scales, such as heating ratio, proportional scale, fan speed, etc.

1. Stand-alone programmable thermostat comprising, an antenna for receiving heating data, digital means for storing and processing the received heating data and a real-time clock, wherein the thermostat is a displayless type programmable thermostat with a setting dial.

2. Stand-alone programmable thermostat according to claim 1, wherein the thermostat comprises a radio connected to the antenna, which antenna is arranged to receive heating data as radio messages, a microcontroller with a memory, which microcontroller is arranged to process and store the received radio messages, which thermostat further comprises a knob to set a base target temperature and a base target temperature sensor by the help of which the microcontroller is arranged to measure the base target temperature set with the knob.

3. Stand-alone programmable thermostat according to claim 1, wherein the heating data comprises one or more sets of heating parameters, which set of parameters comprises target thermostat identification information, date information, target temperature information, starting time information and finishing time information.

4. Stand-alone programmable thermostat according to claim 1, wherein the thermostat comprises means to receive the heating data sent via Bluetooth and/or Wi-Fi and/or other mobile network standards.

5. Stand-alone programmable thermostat according to claim 1, wherein the thermostat is arranged to receive a week and/or day heating program, settings and time as radio messages through the antenna from a mobile device.

6. Stand-alone programmable thermostat according to claim 5, wherein the received week and/or day heating program is stored into the memory of the microcontroller, and the received time is stored into the real-time clock.

7. Stand-alone programmable thermostat according to claim 5, wherein the thermostat comprises a physical means to adjust the temperature directly from the thermostat and an indicator, which is arranged to indicate when the thermostat uses the received week and/or day heating program, overriding the thermostat's physical temperature setting.

8. Stand-alone programmable thermostat according to claim 5, wherein the microcontroller is arranged to measure temperature data with sensors, and based on the temperature measurements, the received and stored week and/or day heating program and the data of the real-time clock the microcontroller is arranged to independently change the base target temperature of the heat control and to control the electric heating device with a relay accordingly.

9. Stand-alone programmable thermostat according to claim 1, wherein the thermostat is installed in the same housing with the electric heating device.

10. Stand-alone programmable thermostat according to claim 1, wherein the heating data received, is a cost optimized heating data, which is based on electricity spot prices.

11. Stand-alone programmable thermostat according to claim 1, wherein the thermostat comprises a means to transmit the received heating data to one or more other/next displayless thermostats.

12. Method for transmitting a data to a stand-alone programmable thermostat, which method comprises a mobile device, a mobile device application, a heating data, an electric heating device, a stand-alone programmable thermostat, which thermostat comprises an antenna for receiving heating data, digital means for storing and processing the received heating data and a real-time clock, wherein the electric heating device is controlled with a displayless dial thermostat which receives the heating data from the mobile device application and/or from a rotatable knob connected to the thermostat.

13. Method according to claim 12, wherein the mobile device application receives the heating data from a user via a user interface of the mobile device.

14. Method according to claim 12, wherein the mobile device application forms and optimizes the heating data based on electricity spot prices data the mobile device receives from the internet.

15. Method according to claim 12, wherein the mobile device application runs automatically in the background of the mobile device, and that the application forms and optimizes online the updated heating data based on electricity spot prices data the mobile device receives from the internet, and that the application automatically transmits the updated heating data to the displayless thermostat when it is in the data connection range of the mobile device.

16. Method according to claim 12, wherein the displayless thermostat transmits the received heating data to one or more other/next displayless thermostats in their data connection range.

17. Stand-alone programmable thermostat according to claim 2, wherein the heating data comprises one or more sets of heating parameters, which set of parameters comprises target thermostat identification information, date information, target temperature information, starting time information and finishing time information.

18. Stand-alone programmable thermostat according to claim 2, wherein the thermostat comprises means to receive the heating data sent via Bluetooth and/or Wi-Fi and/or other mobile network standards.

19. Stand-alone programmable thermostat according to claim 3, wherein the thermostat comprises means to receive the heating data sent via Bluetooth and/or Wi-Fi and/or other mobile network standards.

20. Stand-alone programmable thermostat according to claim 2, wherein the thermostat is arranged to receive a week and/or day heating program, settings and time as radio messages through the antenna from a mobile device.
